(19) United States
(12) Patent Application Publication
(10) Pub. No.: US 2009/0119692 A1
(43) Pub. Date: May 7, 2009

(54) Optical Pickup Device and Optical Disc Apparatus Using the Same

(76) Inventors: Shinya Fujimori, Yokohama (JP); Nobuyuki Maeda, Yokohama (JP); Tetsuo Ito, Yokohama (JP); Shoji Ueda, Machida (JP); Shinya Iizaka, Yokohama (JP); Akihiro Ooba, Yokohama (JP); Shoji Matsumoto, Kawasaki (JP); Katsuhiko Kimura, Fujisawa (JP); Toru Shibata, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/265,742

(22) Filed: Nov. 6, 2008

(30) Foreign Application Priority Data
Nov. 7, 2007 (JP) 2007-290057

(51) Int. Cl. G11B 33/12

(52) U.S. Cl. 720/652; G9B/33.026

(57) ABSTRACT

An optical pickup device includes an optical system unit, a circuit board to control the optical system unit, and send and receive signals, a housing to place the optical system unit and the circuit board, and a flexible printed circuit board to connect electrically with the circuit board, extend to an outside from the housing, and fold back an extended portion, an extended direction of which is changed, in which the flexible printed circuit board is folded back so as to be faced to a side surface of the housing positioned at an extended proximal portion of the flexible printed circuit board, and a dead space of an optical disc apparatus to be mounted with the optical pickup device can be effectively used without making the apparatus large and thick, taking an inner space widely.

### INCORPORATION BY REFERENCE

The present application claims priority from Japanese application JP 2007-290057 filed on Nov. 7, 2007, the content of which is hereby incorporated by reference into this application.

### BACKGROUND OF THE INVENTION

The present invention relates to an optical pickup device and an optical disc apparatus mounting with the same, for recording and/or reproducing information in and/or from an optical information recording medium (hereinafter, referring to as “optical disc”) such as BD (Blue-ray Disc), HD-DVD (High Definition Digital Versatile Disc), DVD, CD, etc.

In the past, there have been proposed optical disc apparatuses to record and/or reproduce information in and/or from three types of optical disc, including BD, DVD and CD. For instance, such optical disc apparatus is mounted in personal computers. Particularly, in the case where the optical disc apparatus is mounted in a notebook-type personal computer etc., it has been demanded that the optical disc apparatus itself is downsized, thin-shaped and lightened in accordance with the demands in these days. It has also been demanded that an optical pickup device is downsized, thin-shaped and lightened to be mounted in the optical disc apparatus.

JP-A-2006-294134 has proposed an optical pickup device to realize the above demands to be downsized, thin-shaped and lightened. This optical pickup device provides a feed mechanism including a spindle motor to rotate an optical disc mounted on an optical disc apparatus, an optical pickup device to record and/or reproduce information in and/or from the optical disc, and a feed motor to move the optical pickup device between inner and outer peripheries of the optical disc. The optical pickup device also provides a detecting sensor placed adjacent to the spindle motor on a side faced to the optical pickup device, and a portion to be detected faced to the detecting sensor and placed on the optical pickup device, and further provides an inner periphery detecting sensor to detect that the optical pickup device arrives at an innermost periphery of the optical disc.

Further, JP-A-2006-120306 and JP-A-2005-327388 have also proposed a technique of realizing that an optical disc apparatus is downsized, thin-shaped and lightened, for providing one optical pickup device used for recording and/or reproducing information in and/or from the three types of optical disc, such as BD, DVD and CD.

### SUMMARY OF THE INVENTION

In these years, there has also been proposed an optical pickup device to be able to record and/or reproduce information in and/or from an optical disc of four types including BD, HD-DVD, DVD and CD. In the case of the above optical pickup device, an optical system becomes more complicated and the number of arrangements for optical components is also increased since the information is recorded and/or reproduced in relation to the four types of the optical disc. Therefore, various artifices, such that a layout for the various optical systems and components is considered, have been conducted for realizing the downsizing and thin-shaping of the optical pickup device.

However, in the case of the existing optical pickup devices, the size of optical pickup device has been downsized and thin-shaped by devising the layout of the various optical systems and components etc. In other words, a housing shape of the optical pickup device has been designed under the condition where the size of optical disc apparatus to be fitted with the optical pickup device is not made large and thick in structure. Expansion for the inner space of the housing has however not been considered. This is a current condition for the optical pickup device.

The present invention is made in light of the above current condition. An object of the invention is to provide an optical pickup device and an optical disc apparatus mounting with the same capable of effectively using a dead space in the optical disc apparatus and of taking an inner space widely.

In order to achieve the above object, the invention provides an optical pickup device to carry out a recording and/or reproducing of information in and/or from an information recording surface on the optical disc. The optical pickup device includes: at least one optical system unit; a circuit board to control the optical system unit and to send and receive signals; a housing to place the optical system unit and the circuit board; and a flexible printed circuit board (hereinafter, referred to as FPC) electrically connected with the circuit board, extended to an outside from the housing, and folded back an extended portion, an extended direction of which is changed. The FPC is folded back so as to be faced to a side surface of the housing positioned at an extended proximal portion of the FPC. The side surface of the housing is curved such that an outer surface of the housing is a convexity toward a folded-back portion of the FPC.

Further, the invention provides an optical disc apparatus mounted with the above optical pickup device used for recording and/or reproducing information in and/or from an information recording surface on an optical disc. The optical disc apparatus includes: an optical pickup device regarding the invention; an optical pickup traveling unit to travel or move the optical pickup device in a radial direction of the optical disc; a disc motor to rotatably drive the optical disc; a chassis to mount with the optical pickup device, the optical pickup traveling unit and the disc motor; and a circuit board to connect with a flexible printed circuit board and provide a signal processing system and a control system.

According to the invention, a dead space in the chassis is used effectively without making the size of optical disc apparatus mounted with the optical pickup device large and thick in structure, so that an inner space of the optical pickup device can be secured widely.

### BRIEF DESCRIPTION THE DRAWINGS

These and other features, objects and advantages of the present invention will become more apparent from the following description when taken in conjunction with the accompanying drawings wherein:

FIG. 1 is a perspective view showing an outline of an optical disc apparatus on which an optical pickup device is mounted in an embodiment of the invention;

FIG. 2 is a perspective view showing a vicinity of the optical pickup device in FIG. 1 seen from the opposite side of an optical disc mounting surface (optical irradiation and receiving surface);

FIG. 3 is a schematic side view showing the optical pickup device in FIG. 1 seen from a side surface along a moving direction, in which the optical pickup device is moved up to a position corresponding to an outer periphery portion of the optical disc;

FIG. 4 is a schematic side view showing the optical pickup device which moves up to a position corresponding to an inner periphery portion of the optical disc;

FIG. 5 is a plan view showing a simplified inner constitution of the optical pickup device in FIG. 2;

FIG. 6 is a side view showing a simplified constitution of a BD optical system in FIG. 3;

FIG. 7 is a side view showing a simplified constitution of optical systems of HD-DVD, DVD and CD;

FIG. 8 is plan view showing a simplified inner constitution of the optical pickup device in another embodiment of the invention; and

FIG. 9 is a side view showing a simplified constitution of optical systems of DVD and CD.

### DESCRIPTION OF THE INVENTION

Next, an optical pickup device and an optical disc apparatus mounted with the optical pickup device in embodiments of the invention will be described with reference to the drawings. In addition, the following embodiments described below are exemplified for describing the invention which is not limited thereto, and various changes and modifications may be made without departing from the spirit of the invention.

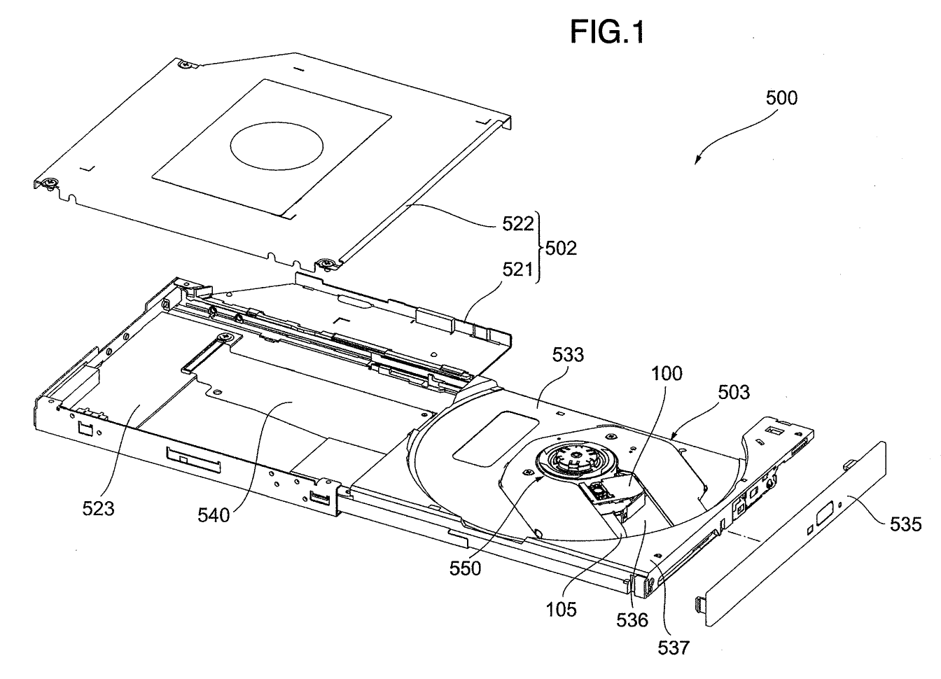

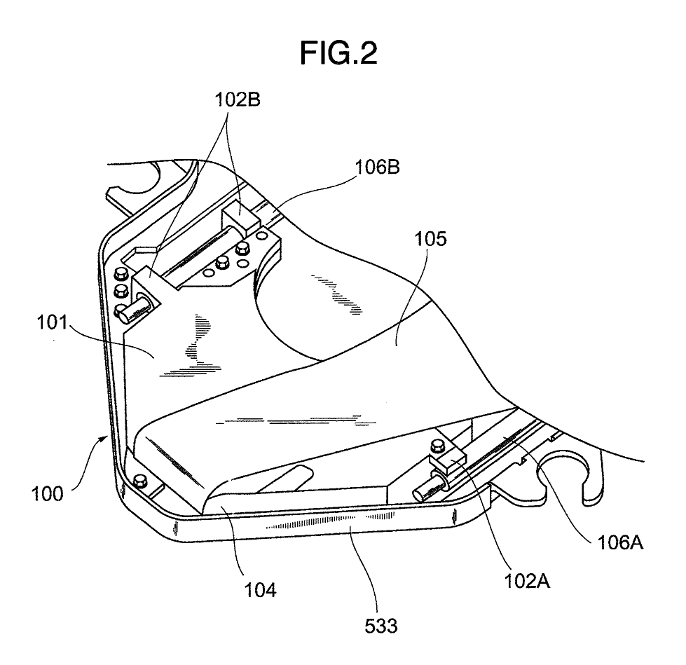

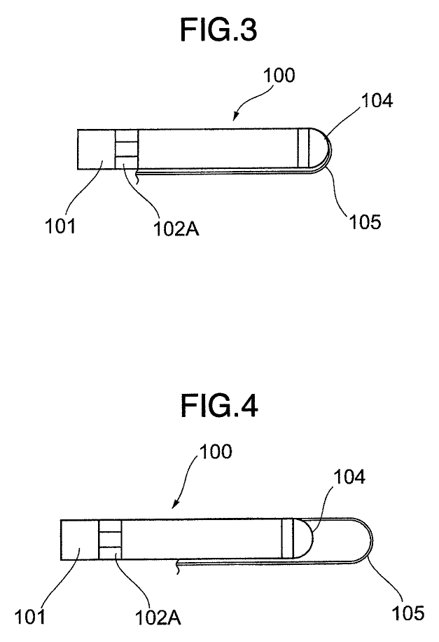

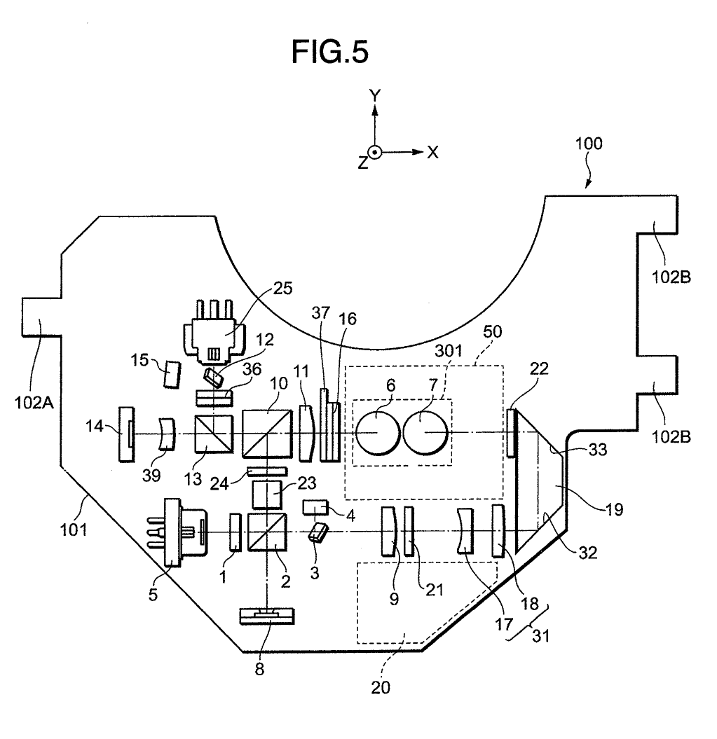

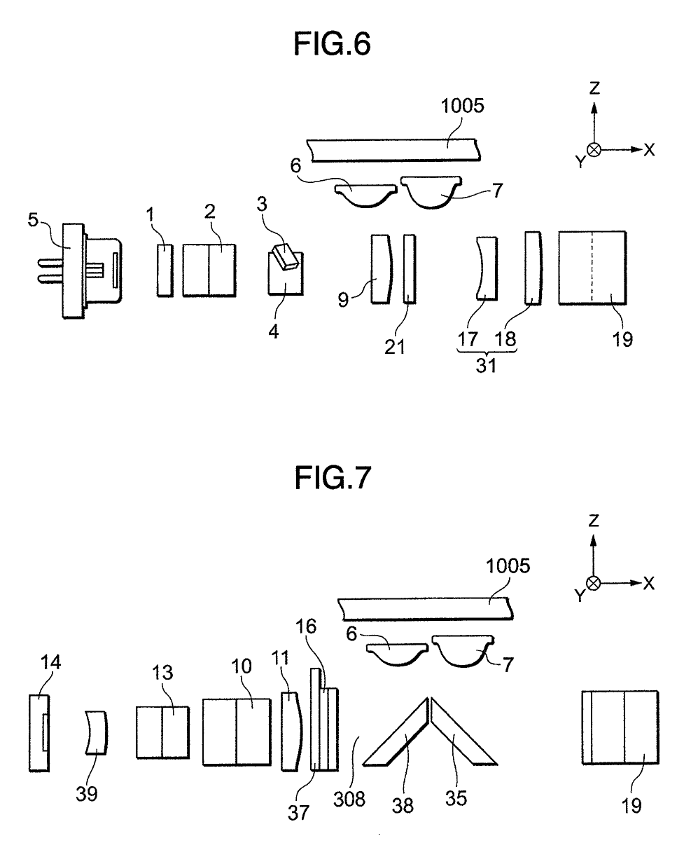

FIG. 1 is a perspective view showing a contour of an optical disc apparatus mounted with an optical pickup device in the embodiment of the invention. FIG. 2 is a perspective view showing a structure seen from an opposite side of an optical disc mounting surface (optical irradiation and reception surface of the optical pickup device) adjacent to the optical pickup device mounted in the optical disc apparatus. FIG. 3 is a side view seen along a moving direction of the optical pickup device of FIG. 1 in a condition where the optical pickup device is traveled or moved up to a position at an outer periphery of the optical disc. FIG. 4 is a side view showing a condition where the optical pickup device shown in FIG. 3 is traveled or moved up to a position along an inner direction of the optical disc. FIG. 5 is a plan view showing a simplified inner constitution of the optical pickup device shown in FIG. 2. FIG. 6 is a side view showing a simplified constitution of an optical system for BD shown in FIG. 3. FIG. 7 is a side view showing a simplified constitution of an optical system for HD DVD, DVD and CD.

In addition, the above drawings are illustrated with a thickness and size of components, an enlargement and reduction ratio, etc. without matching with practical structure since the description will be easily understood. Further, An X direction shown in FIG. 5 to FIG. 7 indicates a tangential direction of the optical disc in which a lateral arrow direction is regarded as +X direction and an opposite direction of the lateral arrow direction is regarded as −X direction. Further, a vertical Y direction shown in FIG. 5 to FIG. 7 indicates a radial direction (traveling or moving direction of the optical pickup device) of the optical disc, in which a vertical arrow direction is regarded as +Y direction corresponding to an inner periphery side of the optical disc, and an opposite direction of the vertical arrow direction is regarded as −Y direction corresponding to an outer periphery side of the optical disc.

As shown in FIG. 1, an optical disc apparatus 500 regarding the embodiment in the invention has a housing 502 and a tray 503 disposed in the housing 502 with insertable/extractable manners. The housing 502 is a casing shape configured by a bottom case 521 and a top case 522 disposed in the bottom case 521. The tray 503 is inserted into the housing 502 from an opening thereof, and extracted from the housing 502 through the opening.

A circuit board 523 is disposed on the bottom case 521 such that it mounts with an electric circuit of a signal processing system and a control system to drive the optical disc apparatus 500. An FPC 540 and after-mentioned FPC 105 are connected with the circuit board 523 via a relay board (not shown).

The tray 503 accommodates an optical pickup device 100, two guide rails 106A, 106B to guide for a travel or movement of the optical pickup device 100, and a chassis 533 to be mounted with a spindle motor 550 for rotatably driving a mounted optical disc 1005. The chassis 533 has an approximately quadrangular shape as seen in a plane, and the optical disc 1005 is mounted on an upper surface as indicated in FIG. 1 (hereinafter, a side on which the optical disc 1005 is mounted is referred to as a “top”). The chassis 533 also has an opening 536 from which part of the optical pickup device 100 is come out. The two guide rails 106A and 106B are provided in parallel toward a corner portion 537 in an insertable/extractable direction of the tray 503, and the optical pickup device 100 can be traveled or moved along the guide rails 106A and 106B in the radial direction of the optical disc 1005. The spindle motor 550 is disposed at a position corresponding to about the center of chassis 533. In addition, a reference numeral 535 denotes a bezel to cover an opening of the housing 502.

The optical pickup device 100 provides an after-mentioned optical system unit for BD, an optical system unit for HD-DVD, DVD and CD, mechanism components to drive the optical system units for BD and for HD-DVD, DVD and CD, and a housing 101 to accommodate a circuit board for controlling the foregoing optical system units and their components and for sending and receiving signals, as shown in FIG. 1 to FIG. 7.

The both sides of housing 101 have respectively engaging portions 102A and 102B to be engaged with the guide rails 106A and 106B such that the housing 101 can travel or move along the rails. The housing 101 is also provided such that a side surface 104 (that is, this side surface is faced to the corner portion 537 on tray 503 when the optical pickup device 100 is mounted on the chassis 533 disposed on the tray 503) positioned at a front edge of the housing 101 in the moving direction, when the housing 101 moves toward an outer periphery direction from the center of optical disc 1005, is formed of a convexly curved shape having a predetermined curvature radius (R). Specifically, the outer surface of side surface 104 is curved convexly toward a direction where the corner portion 537 is formed, and the inner surface thereof is curved concavely toward the direction where the corner portion 537 is formed, so as to suit to the convex curve. Therefore, the housing 101 has an inner space increased by a space where the side surface 104 is curved concavely.

Further, in the optical pickup device 100, an FPC 105 is extendedly come out from an upper side of the side surface 104. One end of the FPC 105 is connected with a circuit board (not shown) disposed in the housing 101, and the extendedly come-out portion of the FPC 105 from the housing 101 is curvedly folded back along the side surface 104 of housing 101, as shown specifically in FIG. 3 and FIG. 4, passed through underneath the housing 101, and electrically connected to the circuit board 523 via a relay board (not shown) and a FPC 540. In this way, it is necessary to secure a space for the FPC 105 to be folded back between the side surface 104 of the housing 101 and a portion to which the side surface 104 of the chassis 533 is faced (around the corner portion 537 in this embodiment), since the FPC 105 is used such that the extendedly come-out portion from the housing 101 is folded back.

Here, since the FPC 105 is folded back with its outside curved as a property as shown in FIG. 3 and FIG. 4, a concavely curved space (dead space)(or convexity seen from outside) exists between the folded-back portion of FPC 105 and the side surface 104 of hosing 101 toward a direction away from the side surface 104. However, in the invention, since the outer surface of side surface 104 is curved convexly toward the folded-back portion of FPC 105, the folded-back portion can be positioned at the space (dead space) formed between the side surface 104 of housing 101 and the folded-back portion of FPC 105. Therefore, it is not necessary to change the shape, size, etc. of the chassis 533 even though the side surface 104 of housing 101 has the convexly curved shape toward outside. For this reason, the inner space of housing 101 can be extended without adversely affecting the downsizing and thin-shaping.

In addition, the side surface 104 is come close to the folded-back portion of FPC 105 when the optical pickup device 100 travels or moves to come closest to the corner portion 537, as shown in FIG. 3. At this time, since the side surface 104 has the curve along the folded-back shape of FPC 105, the FPC 105 can be prevented from being fatigue and damage even though the side surface 104 is contacted with the FPC 105.

As shown in FIG. 5 to FIG. 7, after-mentioned optical system components for BD and for HD-DVD, DVD, CD, and mechanism parts are accommodated in the housing 101. In addition, the BD optical system components are used for recording and/or reproducing information in/from an information recording surface of the BD. On the other hand, the following describing components: a blue-violet laser optical source 5, a polarization conversion element 1, a polarization separation element 2, a mirror 3, and a front monitor 4, are also used for recording information in the information recording surface of HD-DVD and/or reproducing the information from the information recording surface of BD.

The BD optical system has the blue-violet laser optical source 5 (first optical source), from which an optical beam is emitted, is used for recording information in BD and HD-DVD and/or reproducing the information from BD. Further, the BD optical system provides, in succession, the polarization conversion element 1, the polarization separation element 2, the mirror 3, a first collimate lens 9, a multi-divisional polarization lattice 21, a concave lens 17, a convex lens 18, and an optical path changing optical element 19, with a predetermined space given between the foregoing components in the system on the basis of the blue-violet laser optical source 5 in the +X direction. The BD optical system also provides a ¼-wavelength plate 22 to convert an optical beam, an optical path of which is changed to an opposite direction, to a circularly polarized beam by the optical path changing optical element 19.

The polarization conversion element 1 is constituted by liquid crystal elements each having a transparent electrode formed by a liquid crystal sandwiched in between glass sheets, and has a conversion portion (not shown) to convert a linear polarization direction of the optical beam into a second direction and transmit it when a predetermined control voltage is applied, and a non-conversion portion to transmit the optical beam in a first direction without converting the linear polarization of the optical beam, even though when the predetermined control voltage is applied. The polarization separation element 2 has a function such that an optical beam of the linear polarization (P polarization) in a ±Y direction is transmitted most totally, and an optical beam of the linear polarization (S polarization) in a ±Z direction perpendicular to the ±Y direction is reflected most totally.

Further, the BD optical system is disposed in an after-mentioned object lens driving unit 50, and also has a first object lens 7 to focus the optical beam converted to the circularly polarized beam by the ¼-wavelength plate 22 on the BD (optical disc 1005 shown in FIG. 6 and FIG. 7), and a start up mirror 35 (referring to FIG. 7) to change the optical path of optical beam incident to the first object lens 7.

Further, the BD optical system provides, in succession, an HD auxiliary prism 23 to which the optical beam reflected by the polarization separation element 2 is incident, and an HD diffraction grating 24 to which the optical beam passed through the HD auxiliary prism 23 is incident, with a predetermined space given in the +Y direction on the basis of the polarization separation element 2. The BD optical system also provides a BD optical detector 8 on the basis of the polarization separation element 2 in the −Y direction to detect the optical beam reflected by the BD. The BD optical system further provides the front monitor 4 on the basis of the mirror 3 in the +Y direction to receive the optical beam reflected by the mirror 3 and detect a light amount of the optical beam. A detected light amount detected by the front monitor 4 is fed back to a control circuit (not shown) of the blue-violet laser optical source 5 to control such that the light amount of optical beam is turned into a desirable value. The BD optical system furthermore provides an expander driving mechanism 20 to move the concave lens 17 in a ±X direction from its reference position and change the incident optical beam from the convex lens 18 to a weak diverging beam or a weak converging beam from parallel beams. In addition, the concave lens 17 and convex lens 18 constitute a beam expander element 31.

In the BD optical system, as shown dotted lines in FIG. 5, a diverging optical beam having a wavelength λ₁=405 nm band and the linear polarization (P polarization), the polarization direction of which is mostly ±Y direction, is emitted from the blue-violet laser optical source 5 to be incident to the polarization conversion element 1. In the case of the embodiment, most of the diverging optical beam of the linear polarization (P polarization) in the ±Y direction transmitted most totally through the polarization separation element 2 is incident to the first collimate lens 9, when information is recorded and/or reproduced in relation to the BD. On the contrary, of the diverging optical beams, an optical beam not used for recording and/or reproducing information in relation to the BD is reflected toward the +Y direction by the mirror 3 to be incident to the front monitor 4.

In the case of this embodiment, since a control voltage is not applied to the polarization conversion element 1 when information is recorded and/or reproduced in relation to the BD, the diverging optical beam is entered from the polarization conversion element 1 without converting the linear polarization (P polarization) in ±Y direction to be incident to the polarization separation element 2. On the contrary, since the control voltage is applied to the polarization conversion element 1 when information is recorded and/or reproduced in relation to the HD-DVD, the linear polarization direction of the optical beam incident to the conversion portion of the polarization conversion element 1 is converted to the ±Z direction (S polarization) perpendicular to the ±Y direction from the ±Y direction (P polarization), and the optical beam incident to the non-conversion portion is transmitted through the polarization conversion element 1 without converting the linear polarization (P polarization) of the ±Y direction.

The optical beam incident to the first collimate lens 9 is converted into parallel optical beams to be incident to the multi-divisional polarization lattice 21. The multi-divisional polarization lattice 21 has a function to make the optical beam of the linear polarization (P polarization) in the ±Y direction transmit through without diffraction, diffract the optical beam of the ±Z direction (S polarization), and diverge to plural optical beams. The parallel optical beams transmit through the multi-divisional polarization lattice 21 without diffraction since they are the linear polarization (P polarization) in the ±Y direction.

Next, the optical beam transmitted through the multi-divisional polarization lattice 21 is converted into the parallel optical beams, a beam flux diameter of which is expanded to as large as 1.1 to 1.5 times by the beam expander element 31 constituted by the concave lens 17 and convex lens 18 to then be incident to the convex lens 18. The beam expander element 31 has a function to make the concave lens 17 to be traveled or moved in a translation drive to the ±X direction from the reference position, and make the optical beam entered from the convex lens 18 to be changed to the weak diverging beam or weak converging beam from the parallel beams. The expander driving mechanism 20 is connected electrically with the FPC 105 which is also connected electrically with an expander driving circuit (not shown). The expander driving mechanism 20 is disposed close to the side surface 104 of the housing 101, and the parallel optical beams entered from the convex lens 18 are incident to the optical path changing optical element 19.

Here, as described above, since the side surface 104 of the housing 101 has a convexly curved shape outwardly, therefore, the inner space of housing 101 is extended at a vicinity of the side surface 104. Consequently, the expander driving mechanism 20 can be disposed at the vicinity of side surface 104.

The optical path changing optical element 19 is formed by a trapezoidal integrated prism having two inner reflection surfaces 32 and 33, both of which are formed orthogonally one another. The parallel optical beams entered from the convex lens 18 are bent, as an optical path, to 90 degrees by the inner reflection surface 32, and the optical path is further bent to 90 degrees by the inner reflection surface 33. The parallel optical beams reflected by the inner reflection surface 33 are converted into a circularly polarized beam by the ¼-wavelength plate 22 to move from the +X direction to −X direction and enter into the object lens driving unit 50.

The object lens driving unit 50 provides a holder 301 in which a first object lens 7 and a second object lens 6 as an optical system component of after-mentioned HD-DVD, DVD and CD are commonly disposed in a tangential direction (±X direction) of the optical disc. The holder 301 contains non-illustrated components, such as a focusing drive circuit, a tracking drive coil, and a tilt drive coil. These components are coupled to a board and a suspension holder through a plurality of suspensions. The board is connected electrically with the FPC 105 fitted to the optical disc apparatus 500, for instance, and the FPC 105 is connected electrically with an object lens drive unit driving circuit (not shown). The first object lens 7 and second object lens 6 are driven with the translation drive (focusing motion) in the ±Z direction by applying a current to a focusing drive coil (not shown), with the translation drive (tracking motion) in the ±Y direction by applying the current to a tracking drive coil (not shown), and with a rotating motion (tilt motion) about an X axis by applying the current to a tilt drive coil (not shown).

The parallel optical beams are converted into a circularly polarized beam by the ¼-wavelength plate 22 to move forward to the −X direction from the +X direction. The optical beam incident to the object lens driving unit 50 is bent, as an optical path, to the +Z direction by the start up mirror 35, incident to the first object lens 7, then focused thereby, and irradiated, as an optical sport, on a track of the information recording surface of the BD. The optical beam reflected from the track on the information recording surface transmits through the first object lens 7 to be turned into parallel optical beams. The parallel optical beams are then reflected by the start up mirror 35, converted into the linear polarization (S polarization) in the ±Z direction by the ¼-wavelength plate 22, and then incident to the optical path changing optical element 19.

The optical beam incident to the optical path changing optical element 19 is bent, as an optical path, to 180 degrees by the inner reflection surfaces 33, 32, and then moved forward to the −X direction. Thereafter, the optical beam transmits through the convex lens 18 and concave lens 17 to be incident to the multi-divisional polarization lattice 21. The optical beam transmitted through the multi-divisional polarization lattice 21 further transmits through the first collimate lens 9 to be turned into a converging beam which is reflected most totally by the polarization separation element 2 and then incident to the BD optical detector 8.

On the other hand, the optical system of HD-DVD, DVD and CD has a 2-wavelength multi-laser optical source 25 (second optical source). An optical beam emitted from the 2-wavelength multi-laser optical source 25 is used for recording and/or reproducing information in and/or from the information recording surface of DVD and CD. Further, the optical system of HD-DVD, DVD and CD provides, in succession, a mirror 12, a DVD/CD diffraction grating 36, and a first 3-wavelength prism 13, with a predetermined space given between the foregoing components in the system in the −Y direction on the basis of the 2-wavelength multi-laser optical source 25. Furthermore, the optical system of HD-DVD, DVD and CD provides, in succession, a second 3-wavelength prism 10, a second collimate lens 11, a 3-wavelength liquid crystal aberration correction element 37, a 3-wavelength-¼-wavelength plate 16, and the second object lens 6 to make the optical beam to be focused on the HD-DVD, DVD and CD, with a predetermined space given between the foregoing components in the system in the +X direction on the basis of the first 3-wavelength prism 13. A start up mirror 38 is further provided in the −Z direction of the second object lens 6, for changing an optical path of the optical beam incident to the second object lens 6, as shown in FIG. 7.

The optical system of HD-DVD, DVD and CD further provides, in succession, a detection lens 39, and a HD-DVD/DVD/CD optical detector 14 for detecting the optical beam reflected from HD-DVD, DVD and CD, with a predetermined space given between the foregoing components in the system in the −X direction on the basis of the first 3-wavelength prism 13. A front monitor 15 is also provided in the −X direction on the basis of the mirror 12 to receive the optical beam reflected by the mirror 12 and detect the light amount of optical beam. A detected light amount by the front monitor 15 is fed back to a control circuit (not shown) of the 2-wavelength multi-laser optical source 25 to control such that the light amount of optical beam is turned into a desirable value.

In the case of recording and/or reproducing information in relation to the information recording surface of HD-DVD, of optical beams emitted from the blue-violet laser optical source 5, the linear polarization direction of the optical beam incident to the conversion portion of the polarization conversion element 1 is converted into the ±Z direction (S polarization) to be incident to the polarization separation element 2, and the optical beam is reflected most totally toward the +Y direction by the polarization separation element 2 to be incident to the HD auxiliary prism 23, as a dashed line shown in FIG. 5. On the contrary, since the optical beam incident to the non-conversion portion of the polarization conversion element 1 is remained as the linear polarization (P polarization) in the ±Y direction, it is transmitted most totally through the polarization separation element 2 to be incident to the mirror 3 by which the optical beam is reflected toward the +Y direction to be incident to the front monitor 4.

The optical beam incident to the HD auxiliary prism 23 is incident to the HD diffraction grating 24 to be diverged to one main-optical beam and two sub-optical beams, reflected most totally by the second 3-wavelength prism 10, and then transmitted through the second collimate lens 11 to be converted into parallel optical beams. The parallel optical beams entered from the second collimate lens 11 are incident to the 3-wavelength liquid crystal aberration correction element 37, converted into a circularly polarized beam by the 3-wavelength-¼-wavelength plate 16, moved forward to the +X direction, and incident to the object lens driving unit 50. In addition, the 3-wavelength-¼-wavelength plate 16 is functioned, as a ¼-wavelength plate, to any cases of optical beam to be irradiated on HD-DVD, DVD or CD.

The optical beam incident to the object lens driving unit 50 is bent, as an optical path, toward the +Z direction by a 3-wavelength start up mirror 38, incident to the second object lens 6 to focus it thereby, and then irradiated, as an optical spot, on the track of the information recording surface of HD-DVD. In addition, the 3-wavelength start up mirror 38 has a function of mostly totaled reflection for the optical beam to be irradiated on the after-mentioned DVD and CD, other than the optical beam to be irradiated on HD-DVD. Further, the second object lens 6 is a compatible object lens to be able to focus the optical beam on any of HD-DVD, DVD or CD.

The optical beam reflected from the track of the information recording surface on HD-DVD transmits through the second object lens 6 to then turn into parallel beams. The parallel beams are then reflected by the 3-wavelength start up mirror 38 to pass through an optical beam passing space 308 in the −X direction. The parallel beams are then converted into the linear polarization (P polarization) in the ±Y direction by the 3-wavelength-¼-wavelength plate 16, and the linear polarization transmits through the 3-wavelength liquid crystal aberration correction element 37 and also transmits through the second collimate lens 11 and turns into a converging optical beam. The converging optical beam is incident to the second 3-wavelength prism 10 to then transmit through the second 3-wavelength prism 10, first 3-wavelength prism 13, and detection lens 39, and to thereby focus it on the HD-DVD/DVD/CD optical detector 14.

In addition, since the HD-DVD/DVD/CD optical detector 14 receives three optical beams, three lattice-shaped optical detecting surfaces are aligned in the ±Z direction (top and bottom direction). In the case of the HD-DVD optical system in the embodiment, it is possible to use astigmatism method or differential astigmatism method for detecting a focusing error signal, and DPP method or DPD method for detecting a tracking error signal as a detecting method of servo signal.

The optical beam is emitted from the 2-wavelength multi-laser optical source 25 when information is recorded and/or reproduced in relation to the information recording surface of DVD and CD. The 2-wavelength multi-laser optical source 25 provides a DVD laser chip (not shown) to emit the optical beam of a wavelength λ₂=660 nm band and a CD laser chip (not shown) to emit the optical beam of a wavelength λ₃=780 nm band.

When information is recorded and/or reproduced in/from the information recording surface of DVD, first, a diverging optical beam of the wavelength λ₂=660 nm band is emitted from the DVD laser chip in the 2-wavelength multi-laser optical source 25, as a dashed line shown in FIG. 5. Of the diverging optical beams, part of the optical beams not used for the recording/reproducing of information in relation to DVD is reflected toward the −Z direction by the mirror 12 to be incident to the front monitor 15. The front monitor 15 detects the light amount of optical beam emitted from the DVD laser chip in the 2-wavelength multi-laser optical source 25 on the basis of the received optical beam. The detected light amount is fed back to a control circuit (not shown) of the 2-wavelength multi-laser optical source 25 to control such that the light amount of optical beam to be irradiated on DVD is turned into a desirable value.

On the contrary, the diverging optical beam not reflected by the mirror 12 is incident to the DVD/CD diffraction grating 36 as an element constituted by two sheets and having a wavelength selectivity. The DVD optical beam of the wavelength λ₂=660 nm band is incident to the DVD/CD diffraction grating 36 to be diverged to one main-optical beam and two sub-beams at an diffraction angle θ₁. The diverging optical beam entered from the DVD/CD diffraction grating 36 is reflected most totally by the first 3-wavelength prism 13, and transmitted through the second 3-wavelength prism 10. Thereafter, the diverging optical beam is converted into parallel beams by the second collimate lens 11, and incident to the object lens driving unit 50 through the same optical path as recorded and/or reproduced information in relation to HD-DVD. The optical path of diverging optical beam is then bent to the +Z direction by the 3-wavelength start up mirror 38, incident to the second object lens 6 to focus it thereby, and then irradiated, as an optical spot, on the track of the information recording surface on DVD.

The optical beam reflected by the track of the information recording surface on DVD is focused on the HD-DVD/DVD/CD optical detector 14 with use of the same optical path as the optical beam reflected from the track on the foregoing HD-DVD. In addition, in the case of the DVD optical system of the embodiment, a DVD optical detecting surface is commonly used with the foregoing HD-DVD optical detecting surface. For this reason, the same system as the HD-DVD optical system can be used for detecting a servo signal.

When information is recorded and/or reproduced in relation to the information recording surface of CD, the diverging optical beam of the wavelength λ₃=780 nm band is emitted from the CD laser chip in the 2-wavelength multi-laser optical source 25. Of the diverging optical beams, part of the optical beams not used for the recording and/or reproducing of information in relation to CD is reflected toward the −Z direction by the mirror 12, and incident to the front monitor 15. The diverging optical beam not reflected by the mirror 12 is incident to the DVD/CD diffraction grating 36. The CD optical beam of the wavelength λ3=780 nm band is incident to the DVD/CD diffraction grating 36 to be diverged to one main-optical beam and two sub-optical beams at a diffraction angle θ₂ different from the diffraction angle θ₁. Thereafter, the diverging optical beam come out from the DVD/CD diffraction grating 36 moves forward the same optical path as used for the recording and/or reproducing of information in relation to DVD, is incident to the second object lens 6 to focus it thereby, and irradiated, as an optical spot, on the track of the information recording surface on CD.

The optical pickup device 100 in the invention provides the polarization conversion element 1 and the optical path changing optical element 19 with two inner reflection surfaces, as an integrated type, in which there is few common optical path in the BD and HD-DVD optical systems, and the optical path is formed of a parallel and right angle structure. Further, a space is provided in structural components which do not impinge on the performance of object lens driving unit 50 such that both the parallel optical beams of the BD and HD-DVD can be passed through the structure components. In this way, the BD optical beam is incident to one object lens from the −X direction, and the HD-DVD optical beam is incident to the other object lens from the +X direction, that is, both the optical beams are incident to the different object lens from the opposite directions each other. Therefore, it is possible to simply realize a layout employed the above optical path, since the optical pickup device 100 in the invention provides a structure where the inner space adjacent to the side surface 104 is extended in the housing 101.

Therefore, the following advantages (1) to (4) can be obtained from realizing the layout employed the above optical path. (1) The optical design, packaging design, etc. are made relatively easy in the BD and HD-DVD optical systems, and it is also possible to make an optimal optical design in the respective optical systems. (2) It is possible to realize an optical pickup device having high productivity since a fabrication control can be independently carried out for the BD and HD-DVD optical systems. (3) It is possible to restrain cost rise of the optical pickup device, since one piece of the blue-violet laser optical source alone having highest cost can commonly be used with the BD and HD-DVD. (4) It is possible to realize a thin-type optical pickup device to be able to mount on a slim-type drive since the object lens driving unit 50 and the optical systems can be disposed flatly without increasing a size in the thickness direction thereof.

In addition, the optical pickup device 100 for recording and/or reproducing information has been described for the BD, HD-DVD, DVD and CD in the embodiment. This is not limited to the invention. The optical pickup device in the invention may provide a constitution to be able to record and/or reproduce information on arbitrary optical discs.

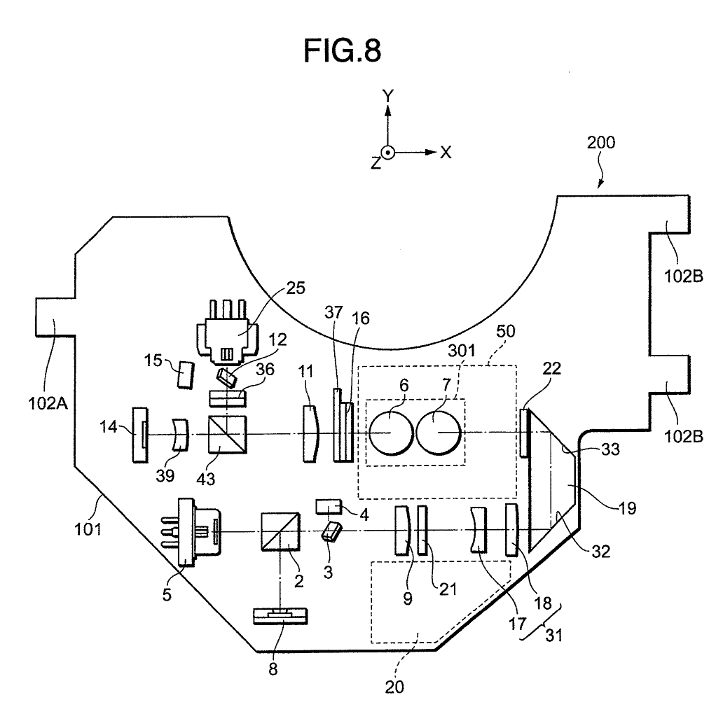

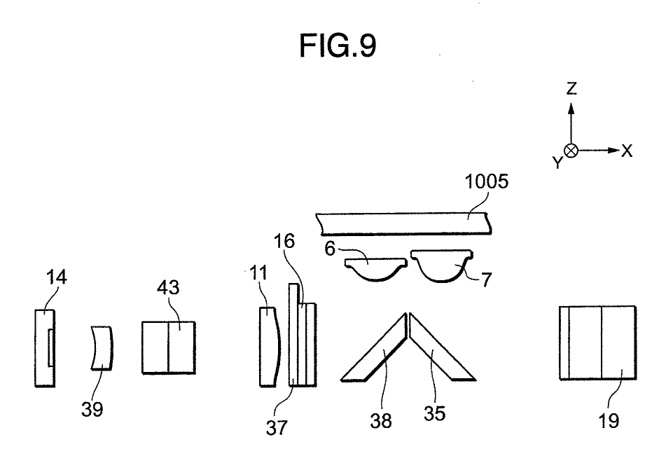

The optical pickup device 100 has been described for recording and/or reproducing the information in relation to the four types of optical disc 1005: BD, HD-DVD, DVD and CD, in the embodiment. This is not limited to the invention. The optical pickup device may be used for recording and/or reproducing information in relation to the three types of optical disc 1005: BD, DVD and CD, as shown in FIG. 8 and FIG. 9.

An optical pickup device 200 shown in FIG. 8 and FIG. 9 provides the polarization conversion element 1 disposed in the housing 101 of the optical pickup device 100 as described in the above embodiment, the HD auxiliary prism 23, and the HD diffraction grating 24, except for the second 3-wavelength prism 10. The optical pickup device 200 also provides a 2-wavelength prism 43 in place of the first 3-wavelength prism 13. In addition, as an alternative instance of the optical pickup device suitable for the three media or BD, DVD and CD, the optical pickup device 200 may provide a half mirror etc. in place of the polarization separation element 2 to change the optical path of optical beam, such that the optical beam is incident to the BD through the foregoing optical path, and the optical beam reflected from the track of the information recording surface on the BD is incident to the BD optical detector 8 via the first object lens 7, the start up mirror 35, the ¼-wavelength plate 22, the optical path changing optical element 19, the convex lens 18, the concave lens 17, the multi-divisional polarization lattice 21, and the first collimate lens 9.

In the case of the DVD and CD optical system in the optical pickup device 200, the optical beam entered from the 2-wavelength multi-laser optical source 25 and reflected most totally by the 2-wavelength prism 43, is converted into parallel beams by the second collimate lens 11, thereafter, incident to the second object lens 6, similarly to the optical pickup device 100, to focus it thereby, and irradiated, as an optical spot, on the track of the information recording surface on DVD or CD.

Further, the embodiment has been described with the case where the side surface 104 positioned at the front edge of the housing 101 in the traveling direction is curved when the housing 101 travels or moves from the inner periphery side to the outer periphery side of the optical disc 1005. This is not limited to the above feature. The housing 101 may provide a structure where the side surface positioned at an extended proximal portion of the FPC 105 is curved. In addition, the FPC 105 can be extended from an arbitrary position of the housing 101 in accordance with the constitution of optical disc apparatus 500 on which the optical pickup device 100 is mounted, the mounting position and moving direction, etc. of the optical pickup device 100.

The curved shape of the side surface 104 can be selected in various ways in response to the housing shape of the optical disc apparatus 500 on which the optical pickup device 100 is mounted, the fold-back shape of FPC 105, the fitting position, the traveling or moving direction, etc. of the optical pickup device 100.

In the case of the optical pickup device in the embodiment, the convexly curved part can be positioned (extended) at the space (dead space) secured for folding back the FPC, since the outer surface of side surface positioned at the extended proximal portion of the FPC is curved with the convexity toward the fold-back portion of FPC, and the inner surface is curved with the concavity toward the fold-back portion. Here, the housing can widely take the inner space by the inner surface which is curved concavely since the inner surface of side surface is curved concavely toward the fold-back portion. Consequently, the dead space is effectively used without enlarging and thickening the size of optical disc apparatus on which the optical pickup device is mounted, so that the inner space of the optical pickup device can be taken widely and used effectively.

In the case of the optical disc apparatus in the embodiment, the previously secured dead space can be used effectively for a space necessary for folding back the FPC, so that the optical pickup device can be realized with downsize and thin-shape.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the admission of the appended claims.

1. An optical pickup device that performs a recording and/or reproducing of information in and/or from an information recording surface on the optical disc, comprising:
at least one optical system unit;
a circuit board which controls the optical system unit, and sends and receives signals;
a housing which places the optical system unit and the circuit board; and
a flexible printed circuit board which is connected electrically with the circuit board, extended to an outside from the housing, and folded back an extended portion, an extended direction of which is changed, wherein
the flexible printed circuit board is folded back so as to be faced to a side surface of the housing positioned at an extended proximal portion of the flexible printed circuit board, and
the side surface of the housing is curved such that an outer surface of the housing is a convexity toward a folded-back portion of the flexible printed circuit board.

2. The device according to claim 1 wherein the side surface of the housing is able to come close to the folded-back portion of the flexible printed circuit board and curved along a folded-back shape thereof.

3. The device according to claim 1 wherein the side surface of the housing is provided on a front edge of the housing in a traveling direction when the housing moves toward an outer periphery direction from a center of the optical disc.

4. The device according to claim 1 wherein the optical system unit comprises:
a first optical system including; a first optical source to irradiate an optical beam on a first optical disc and a second optical disc which are different type one another, a first object lens to focus an optical beam emitted from the first optical source on the first optical disc, and a first optical element module to enter the optical beam emitted from the first optical source into the first object lens, and
a second optical system including; the first optical source, a second object lens to focus the optical beam emitted from the first optical source on the second optical disc, and a second optical element module to enter the optical beam emitted from the first optical source into the second object lens, wherein
the first object lens and the second object lens are disposed in a common object lens driving unit, and the optical beams incident to the first object lens and the second object lens are incident to the object lens driving unit from different directions each other.

5. The device according to claim 4 wherein the second optical system further includes a second optical source which focuses an optical beam having a wavelength different from that of the optical beam emitted from the first optical source on a third disc and a fourth disc different from types of the first and second discs, and a third optical element module which enters the optical beam emitted from the second optical source into the second object lens.

6. The device according to claim 4 wherein the first optical element module further includes a changing element to change an optical path of an optical beam transmitted through a polarization separation element to an opposite direction and to be incident to the object lens driving unit.

7. An optical disc apparatus mounted with an optical pickup device used for recording and/or reproducing information in and/or from an information recording surface on an optical disc, comprising:
an optical pickup device including at least one optical system unit, a circuit board which controls the optical system unit and sends and receives signals, a housing which places the optical system unit and the circuit board, and a flexible printed circuit board which is connected electrically with the circuit board, extended to an outside from the housing, and folded back an extended portion, an extended direction of which is changed, wherein the flexible printed circuit board is folded back so as to be faced to a side surface of the housing positioned at an extended proximal portion of the flexible printed circuit board, and the side surface of the housing is curved such that an outer surface of the housing is a convexity toward a folded-back portion of the flexible printed circuit board;
an optical pickup device traveling unit which moves the optical pickup device in a radial direction of the optical disc;
a disc motor which rotatably drives the optical disc;
a chassis which mounts with the optical pickup device, the optical pickup traveling unit and the disc motor; and
a circuit board which connects with the flexible printed circuit board and provides a signal processing system and a control system.

8. The apparatus according to claim 7 wherein the chassis has an approximately quadrangular shape as seen in a plane, and
the optical pickup device travels or moves on a diagonal line of the chassis, and is disposed on the chassis such that the side surface of the housing positioned at the extended proximal portion of the flexible printed circuit board is faced to a corner portion of the chassis.
